(19) United States
(12) Patent Application Publication
(10) Pub. No.: US 2023/0421048 A1
(43) Pub. Date: Dec. 28, 2023

(54) AUTO PHASE SCALING FOR DYNAMIC VOLTAGE ID

(71) Applicant: Intel Corporation, Santa Clara, CA (US)

(72) Inventors: Patrick Kam-shing Leung, Portland, OR (US); Fazli Lut Ahmad Fu'aad, Simpang Ampat (MY); Jianwei Dai, Portland, OR (US); Philip Lehwalder, Hillsboro, OR (US)

(21) Appl. No.: 17/982,318

(22) Filed: Nov. 7, 2022

Related U.S. Application Data
(60) Provisional application No. 63/356,219, filed on Jun. 28, 2022.

(51) Int. Cl. H02M 1/084; H02M 1/00

(52) U.S. Cl. CPC H02M 1/084; H02M 1/0048; H02M 1/0009

(57) ABSTRACT

Various embodiments provide apparatuses, systems, and methods for automatic phase scaling (APS) of dynamic voltage ID (DVID) in a voltage regulator. Other embodiments may be described and claimed.

### CROSS REFERENCE

The present application claims priority to U.S. Provisional Patent Application No. 63/356,219, filed Jun. 28, 2022, which is hereby incorporated by reference in its entirety.

### FIELD

Embodiments of the present disclosure relate generally to the technical field of electronic circuits, and more particularly to automatic phase scaling for dynamic voltage ID (DVID).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Many electronic circuits include one or more voltage regulators (VRs) to provide a regulated output voltage. Some VRs are used to power the electronic circuit (e.g., system-on-chip (SoC)) with dynamic voltage capability so that Voltage ID (VID) and/or voltage can be optimized for any frequency work point. When running a workload, the SoC power control unit (P-unit) controls the VR to change VID to its optimal work point, and the VID changes may be frequent.

Typically, the VR turns on all phases when a VID change command (e.g., SetVID) is received. In conjunction, the P-unit uses the Slow Slew Rate (SetVID_Slow) to change VID when the operating frequency changes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a graph to illustrate VR loss in various phase counts of a VR.

FIG. 2 illustrates an energy consumption comparison between fast and slow slew.

FIG. 3A illustrates a dynamic VID step size distribution.

FIG. 3B illustrates a duration in VID distribution.

FIG. 4 illustrates a DVID loss sensitivity with different slew rates.

FIG. 5 illustrates a VR output current flow and current sensing in accordance with various embodiments.

FIG. 6 illustrates VR efficiency per phase count and automatic phase scaling (APS) threshold in accordance with various embodiments.

FIG. 7 illustrates a flow chart of a process for APS for DVID in accordance with various embodiments.

FIG. 8 illustrates potential DVID VR loss saving with APS across different slew rates, in accordance with various embodiments.

FIG. 9 illustrates an example system configured to employ the apparatuses and methods described herein, in accordance with various embodiments.

### DETAILED DESCRIPTION

Embodiments herein may address the large VR losses due to Dynamic VID change by applying auto phase scaling. For example, various embodiments herein may allow the VR to dynamically adjust the active VR phase count during slew events so that slew times are met with reduced power loss relative to the lossy methodology of turning on all phases during slew. Accordingly, the VR loss may be reduced significantly during VR slew events.

As discussed above, a VR may include a dynamic voltage capability so that VID and/or output voltage can be optimized for any frequency work point. When running a workload, the SoC P-unit controls the VR to change VID to its optimal work point. The VID changes may be frequent.

In typical implementations, the VR turns on all phases when a VID change (SetVID) command is received. In conjunction, slow slew rate (SetVID_Slow) may be used to change VID when frequency changes to avoid an over current condition.

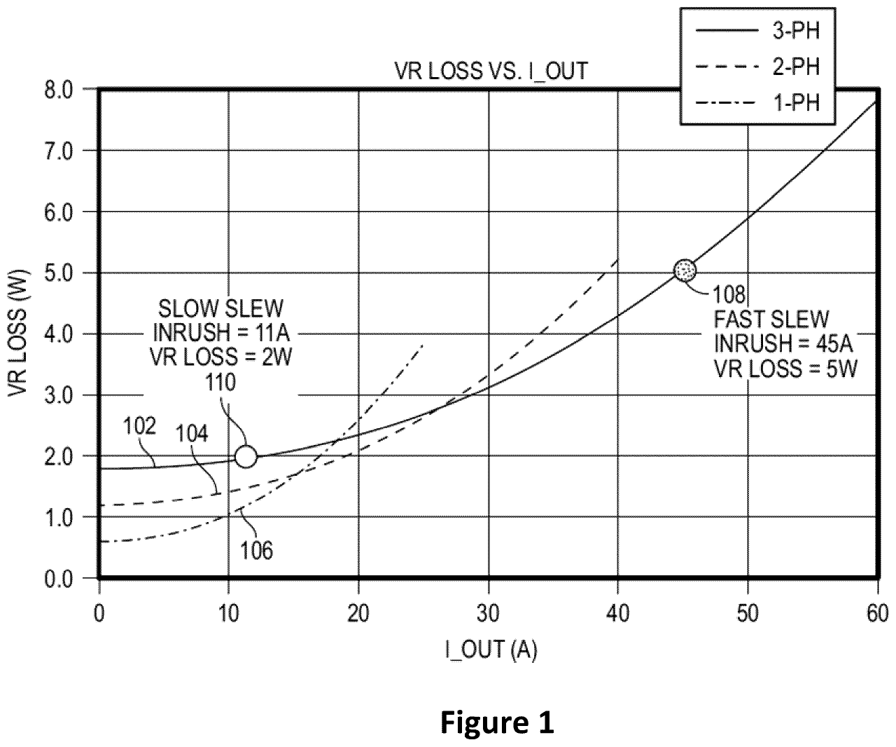

During a SetVID_Slow operation, the slew rate may be less than, e.g., ½ to ⅛ of, the fast slew rate. As a result, the inrush current (e.g., i=C*dV/dt) with slow slew rate is less than the max inrush current associated with the fast slew rate. FIG. 1 illustrates an example of VR loss (in Watts) vs. output current Iout (in Amps) for a 3-phase voltage regulator, including a first curve 102 with three phases active, a second curve 104 with two phases active, and a third curve 106 with one phase active. FIG. 1 further illustrates an example operating point 108 for fast slew and an example operating point 110 for slow slew, both with three phases active. As shown, with three phases active, inrush current with fast slew is ˜45 A and VR loss is ˜5 W, while inrush current with slow slew (¼ of fast slew rate) is ˜11 A and VR loss is ˜2 W.

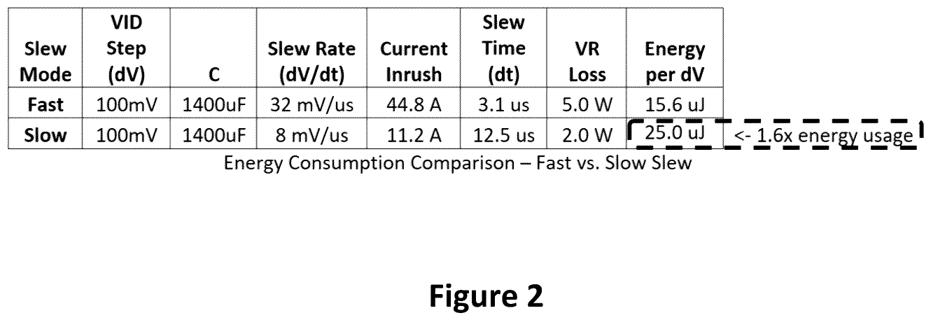

The conventional belief is that slewing slower lowers VR losses and results in improved battery life. FIG. 2 shows a summary comparison of energy consumption with all phases active for fast and slow slew rates. With slow slew rate, slew time is increased by 4× but the VR losses are only ˜2.5× lower than for fast slew. The result of energy usage is actually 1.6× higher (worse) than that of a fast slew.

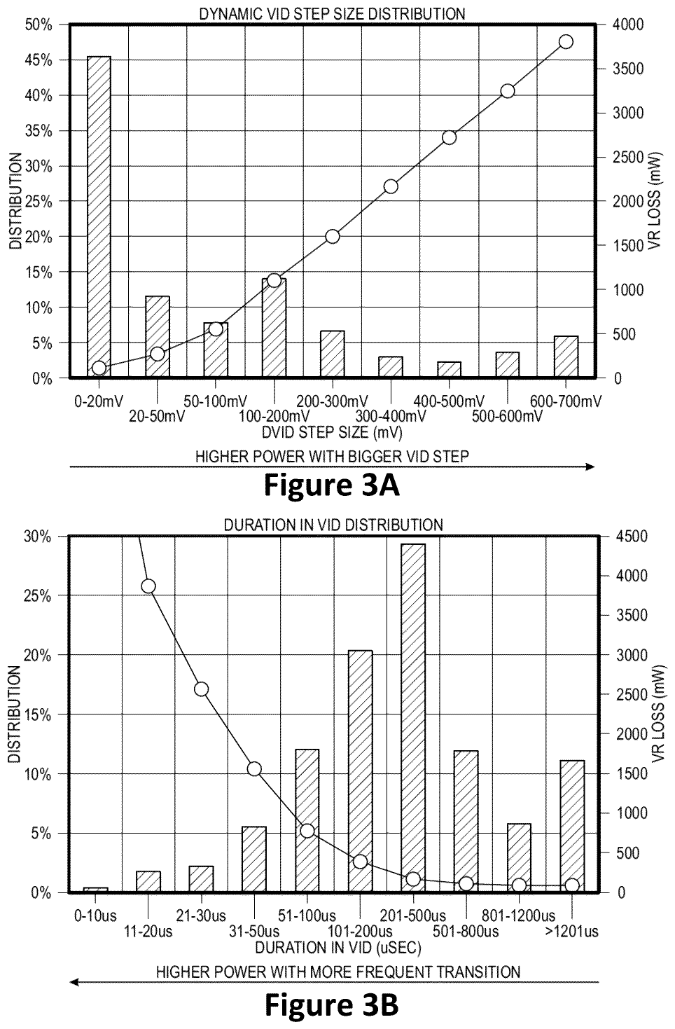

Over the course of a workload, the overall power consumption, or VR loss, contributed by DVID varies with VID step size and the frequency of VID change. Higher VR loss is incurred with larger VID steps (see FIG. 3A) and more frequent VID changes (e.g., shorter VID residency/VID duration, see FIG. 3B).

FIGS. 3A and 3B also show the residency of VID step and VID duration when the SoC is running a 3×3 video conferencing workload. The raw VR loss from SoC core consumption in this example is ˜730 mW, and the DVID VR loss contributes additional 19-37% to the existing VR loss driven by output current (SOC load current). Aggregating the residency and VR loss, the overall additional VR loss due to Slow (Fast/4) and Slow (Fast/8) DVID transitions is in the 140-270 mW range.

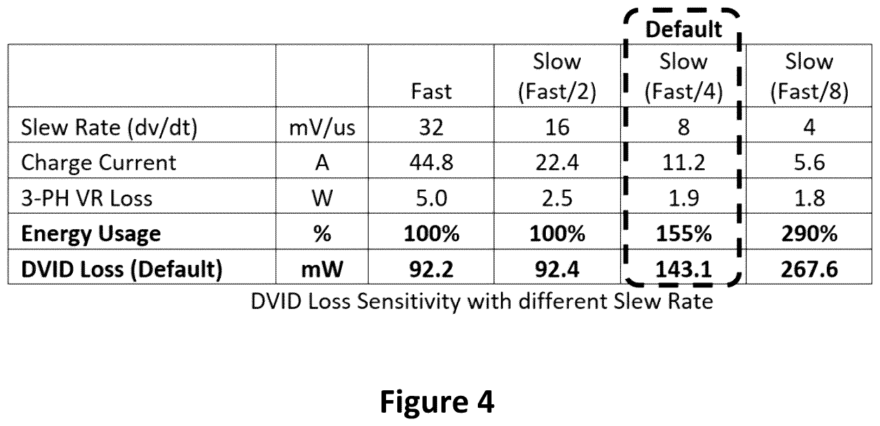

In addition, because faster slew rate is prone to acoustic noise, many original equipment manufacturers (OEMs) prefer using slower slew rate in order to reduce acoustic noise in real designs. As the slew rate is reduced further, the DVID VR loss increases significantly as shown in FIG. 4.

Embodiments herein may address the large VR losses due to Dynamic VID change by applying auto phase scaling. For example, various embodiments herein may allow the VR to dynamically adjust the active VR phase count during slew events so that slew times are met with reduced power loss relative to the lossy methodology of turning on all phases during slew. Accordingly, the VR loss may be reduced significantly during VR slew events.

Embodiments are described with reference to a 3×3 video conferencing workload as a case study. However, the embodiments described herein may be applied to many different implementations.

Embodiments may provide lower VR conversion loss (e.g., increased efficiency). With respect to workloads like video conferencing, the techniques described herein may save power, e.g., 50-160 mW, during active workload. In the overall system context, the embodiments herein may extend overall platform battery life.

Predicting the Output Current During Slew (e.g., Load Current+Inrush Current)

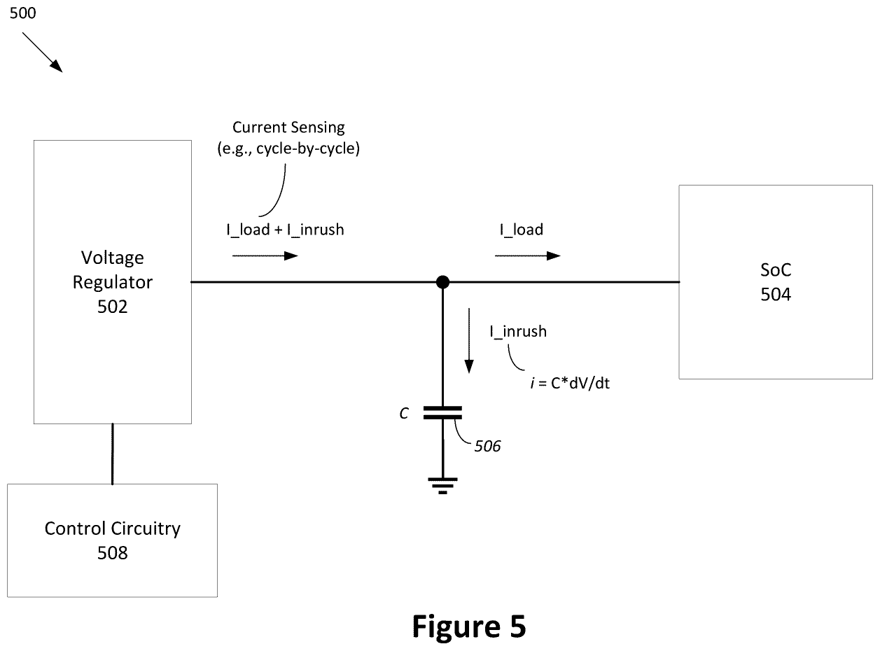

FIG. 5 illustrates a circuit 500 in accordance with various embodiments. The circuit 500 includes a VR 502 and a SoC 504. The VR 502 may provide a regulated output voltage to the SoC 504. In some embodiments, some or all of the VR 502 may be integrated on a same integrated circuit as the SoC 504. The SoC 504 may include one or more processors, memory, controllers, and/or other suitable circuitry. In other embodiments, the VR 502 may be used with another type of load instead of or in addition to SoC 504.

The circuit 500 may further include an output capacitance 506 coupled to an output of the VR 502. The output capacitance 506 is represented in FIG. 5 as a capacitor coupled between the output of the VR 502 (and input of the SoC 504) and ground. However, in implementations of various embodiments, the output capacitance 506 may be implemented using any suitable number and/or configuration of capacitors and/or other devices.

The circuit 500 may further include control circuitry 508 coupled to the VR 502. The control circuitry 508 may control operation of the VR 502, including controlling a number of phases of the VR 502 that are active. The VR 502 may include any suitable number of phases, such as 2, 3, 4, 8, etc.

As discussed herein, the control circuitry 508 may receive a set VID command to change a VID of the VR 502, and may determine the number of phases of the VR 502 to make active based on a total current to be sourced by the VR 502 as it slews the output voltage up. As shown in FIG. 5, the current provided by the VR 502 may include a load current (I_load) that is provided to the load (e.g., SoC 504) and an inrush current (I_inrush) that is provided to the output capacitance 506. In existing implementations, the VR controller senses current on each switching cycle (e.g., through the power stage or through inductor direct current resistance (DCR) sensing), which means that the VR knows the load current (I_load) that is going to the load. However, existing VR controllers have no knowledge of the inrush current.

When there is no DVID transition, the inrush current is 0 A and the VR output current is the load current. Accordingly, the current sensed at the output of the VR 502 will be equal to the load current (I_load). However, when there is a DVID transition, the VR 502 sees a sum of the load current (I_load) and the inrush current (I_inrush). Accordingly, in embodiments herein, the control circuitry 508 may estimate the inrush current and determine a total current to be provided during the slew based on the sensed output current and the estimated inrush current.

In embodiments, the control circuitry 508 may determine the inrush current based on the VR slew rate (dV/dt) and the output capacitance (C). The slew rate (e.g., fast slew rate and/or slot slew rate) and output capacitance may be predefined during VR design, e.g., by electrical requirements. Accordingly, the slew rate and output capacitance may be stored (e.g., in registers within and/or accessible by the control circuitry 508) and used to calculate DVID inrush current, e.g., as I_inrush=C*dv/dt. Accordingly, when the control circuitry 508 receives a VID change command (e.g. SetVID Fast or Slow), it can predict the inrush current requirement in addition to the measured output current Iout.

Determining Optimal Phase Count Thresholds as a Function of Output Current

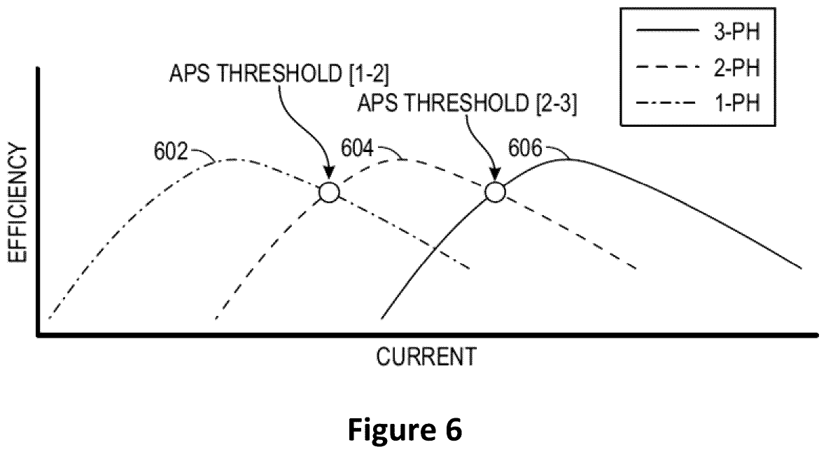

In various embodiments, the control circuitry 508 may compare the sum of the estimated inrush current and the sensed load current with one or more APS thresholds to determine the number of phases of the VR 502 that should be active. In some embodiments, the efficiency curve of each phase operation may be simulated (e.g., during design stage) to obtain the actual efficiency curves for different mode of operation during validation phase. FIG. 6 illustrates one example of efficiency curves for a VR with 3 phases, showing an efficiency curve 602 with one phase active, an efficiency curve 604 with two phases active, and an efficiency curve 606 with three phases active.

The APS thresholds may be determined by finding the cross over point between the curves for the different modes (e.g., number of active phases). Once known, this APS threshold information can also be stored in registers within or accessible to the control circuitry 502 and used to determine/adjust the optimal active phase count during VR run time. For example, as shown in FIG. 6, a first threshold (APS threshold [1-2]) may be defined by the crossover point between the efficiency curve 602 for one active phase and the efficiency curve 604 for two active phases. A second threshold (APS threshold [2-3]) may be defined by the crossover point between the efficiency curve 604 for two active phases and the efficiency curve 606 for three active phases. If the sum of the estimated inrush current and the sensed load current is less than the first threshold, then one active phase may be used. If the sum is greater than the first threshold and less than the second threshold, then two active phases may be used. If the sum is greater than the second threshold, then three active phases may be used.

Note that the determination of the number of active phases based on the sum of the estimated inrush current and the sensed load current may be performed in parallel with the ongoing APS procedure based on the sensed load current only (e.g., based on a comparison of the sensed load current with one or more APS thresholds, which may be the same as or different than the APS thresholds described with respect to FIG. 6). Accordingly, the controller may use the greater of a first number of phases that is determined based on the sum of the estimated inrush current and the sensed load current and a second number of phases that is determined based on the sensed load current only.

It will be understood that similar techniques may be used with a VR having another number of phases in accordance with various embodiments.

Example APS Procedure

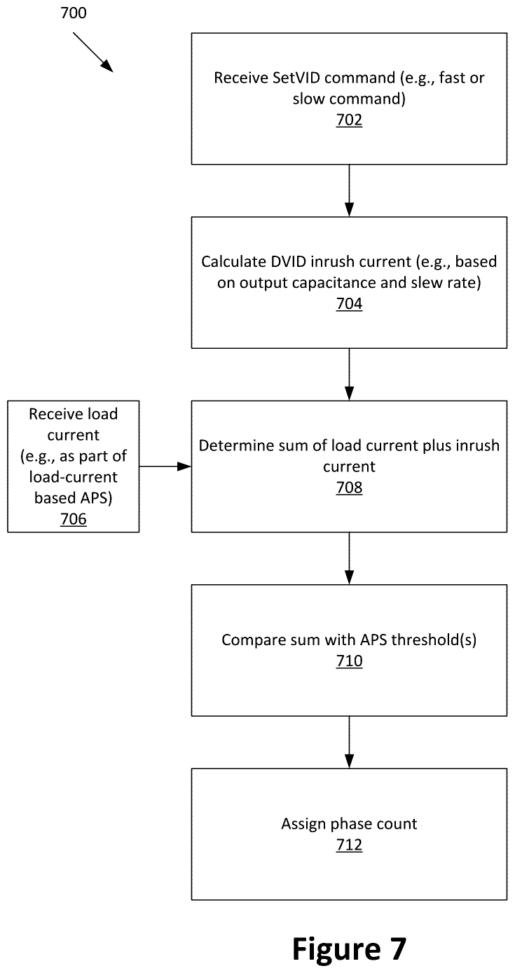

FIG. 7 illustrates an example control flow chart for a process 700 of APS for DVID, in accordance with various embodiments. The process 700 may be performed by control circuitry associated with a VR, such as control circuitry 508 associated with VR 502. The VR may provide a supply voltage to a load, such as an SoC (e.g., SoC 504).

At 702, the control circuitry receives a SetVID command. The SetVID command may be received from the SoC, e.g., from a p-unit of the SoC. The SetVID command may indicate an updated setpoint for the output voltage of the VR 502 and a slew rate (e.g., a fast or slow slew rate, which may be predefined). In embodiments, the SetVID command may serve as an interrupt to trigger the process 700.

At 704, the control circuitry calculates an estimate of the inrush current, e.g., using i=C*dV/dt, where C is the output capacitance and dV/dt is the VR output voltage slew rate associated with the SetVID command.

At 706, the control circuitry receives a sensed current that corresponds to the load current (I_load). The sensed current may be the same as is used for the parallel process of sensed current-based APS (e.g., without taking into account the estimated inrush current). For example, the sensed current may be sensed at an output of the VR and/or at an input of the load.

At 708, the control circuitry determines a total VR output current based on a sum of the estimated inrush current and the sensed current (e.g., Isum=I_inrush+I_load).

At 710, the control circuitry compares the sum against one or more of the APS thresholds to determine a number of phases of the VR to be activated. As discussed above, the APS thresholds may be predetermined and stored in registers. For example, the VR controller may enable only the required number of phases to properly slew the output with minimized power loss (e.g., optimized VR efficiency). As an example, if Isum is less than APS Threshold [1-2], then VR may set phase operation to 1 phase as this is the optimal phase count to slew the output in the lowest power loss. Different phase count may be assigned when the Isum falls in different ranges of APS threshold.

At 712, the control circuitry assigns the phase setting to the VR. This may complete the interrupt routine of process 700.

As discussed above, in some embodiments, the control circuitry may perform a parallel APS process based on the sensed current only, without taking into account the estimated inrush current.

In some embodiments, the control circuitry may choose to turn on all the phases and/or increase the duty cycle at the initial stage of the DVID transition (e.g., to overcome the electrical inertia of the output filter), and then scale down the phase count and/or duty cycle to the number determined by the process 700, e.g., to provide optimal conditions for minimized power loss during slew events. For example, the phase count may be set to the determined number of phases based on a time elapsed from the DVID transition, an amount of current delivered, a value and/or rate of change of the output voltage, and/or another suitable parameter.

Modeled Results

As SoCs progress through generations, VR solutions have to accommodate decoupling solutions that are growing in size due to SoC constraints. In response, SoCs are forced to slow the VR slew rate to keep the total current (e.g., I_load+I_inrush) under control. The side effect of this direction is that the VR DVID losses (e.g., total energy spent during DVID) become worse as the DVID slew rate slows because the VR spends more time changing the output voltage with all phases running in a non-APS VR design.

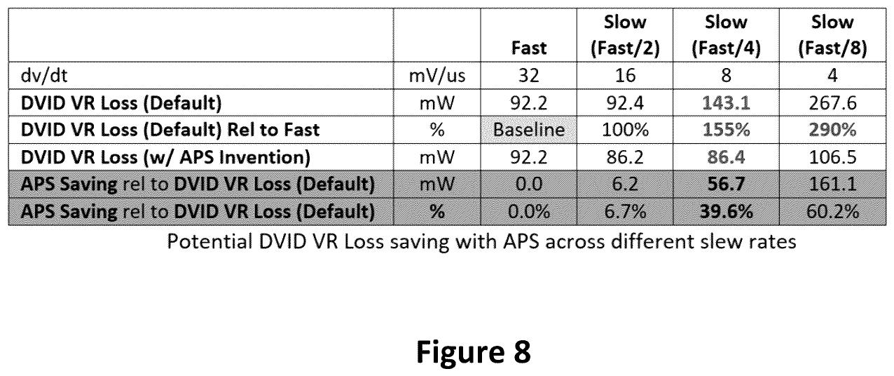

FIG. 8 summarizes DVID VR loss across different slew rates for the following cases:
DVID VR loss (Default)—No APS where the VR turns on all phases when it slews the VR output.
DVID VR Loss (w/APS)—APS case where VR turns on only the require number of phases to slew the output with lowest VR losses.

APS Power Savings Benefits

Looking at the DVID VR Loss (Default) row of FIG. 8, it can be seen that the VR losses increase to the range of 155% to 290% of the fast rate baseline for Slow(Fast/4) and Slow(Fast/8) slew rates for a conventional VR. Introducing this APS technique clearly shows that APS produces much lower DVID VR losses across all slow slew rate modes. As an example, looking at the DVID VR Loss (Default) and DVID VR Loss (w/APS) rows, it can be seen that for Slow (Fast/4) slew rate the power loss is reduced from 143.1 mW to 86.4 mW with the APS scheme described herein, a savings of 56.7 mW (39.6%) using APS.

Based on this data comparison, it is clear that high VR loss due to dynamic VID change can be improved with APS. This case study demonstrates that APS can potentially save approximately 50 mW to 160 mW of power during active workload like video conferencing. Enabling this APS scheme will result in lower VR conversion loss (higher efficiency) and will help to extend overall platform battery life.

Example System

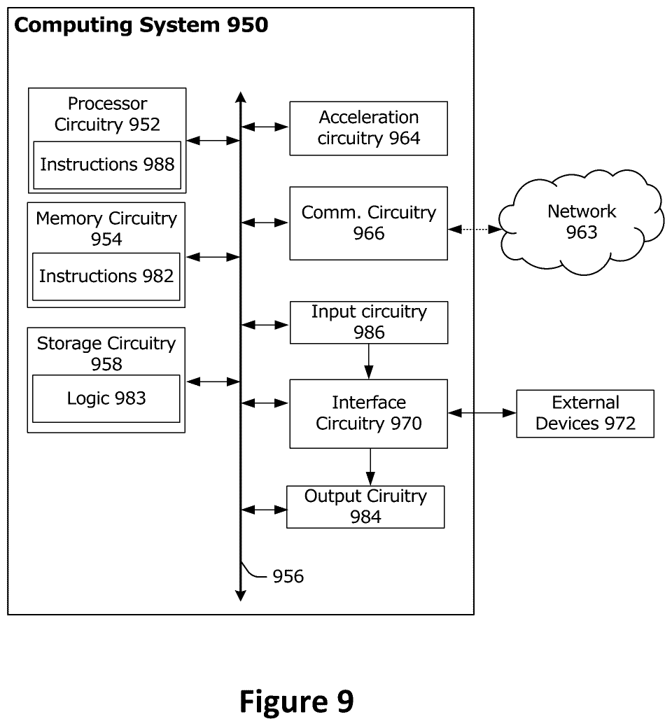

FIG. 9 illustrates an example of components that may be present in a computing system 950 for implementing the techniques described herein. The computing system 950 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 950, or as components otherwise incorporated within a chassis of a larger system. For one embodiment, at least one processor 952 may be packaged together with computational logic 982 and configured to practice aspects of various example embodiments described herein to form a System in Package (SiP) or a System on Chip (SoC).

The system 950 includes processor circuitry in the form of one or more processors 952. The processor circuitry 952 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 952 may include one or more hardware accelerators (e.g., same or similar to acceleration circuitry 964), which may be microprocessors, programmable processing devices (e.g., FPGA, ASIC, etc.), or the like. The one or more accelerators may include, for example, computer vision and/or deep learning accelerators. In some implementations, the processor circuitry 952 may include on-chip memory circuitry, which may include any suitable volatile and/or non-volatile memory, such as DRAM, SRAM, EPROM, EEPROM, Flash memory, solid-state memory, and/or any other type of memory device technology.

The processor circuitry 952 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 952 may be coupled with or may include memory/storage and may be configured to execute instructions stored in the memory/storage to enable various applications or operating systems to run on the platform 950. The processors (or cores) 952 is configured to operate application software to provide a specific service to a user of the platform 950. In some embodiments, the processor(s) 952 may be a special-purpose processor(s)/controller(s) configured (or configurable) to operate according to the various embodiments herein.

As examples, the processor(s) 952 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 952 may be a part of a system on a chip (SoC), System-in-Package (SiP), a multi-chip package (MCP), and/or the like, in which the processor(s) 952 and other components are formed into a single integrated circuit, or a single package, such as the Edison™ or Galileo™ SoC boards from Intel® Corporation. Other examples of the processor(s) 952 are mentioned elsewhere in the present disclosure.

The system 950 may include or be coupled to acceleration circuitry 964, which may be embodied by one or more artificial intelligence (AI)/machine learning (ML) accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 964 may comprise logic blocks or logic fabric and other interconnected resources that may be programmed (configured) to perform various functions, such as the procedures, methods, functions, etc. of the various embodiments discussed herein. In such implementations, the acceleration circuitry 964 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 952 and/or acceleration circuitry 964 may include hardware elements specifically tailored for machine learning and/or artificial intelligence (AI) functionality. In these implementations, the processor circuitry 952 and/or acceleration circuitry 964 may be, or may include, an AI engine chip that can run many different kinds of AI instruction sets once loaded with the appropriate weightings and training code. Additionally or alternatively, the processor circuitry 952 and/or acceleration circuitry 964 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 952 and/or acceleration circuitry 964 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 950 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 950 also includes system memory 954. Any number of memory devices may be used to provide for a given amount of system memory. As examples, the memory 954 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 954 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 954 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 958 provides persistent storage of information such as data, applications, operating systems and so forth. In an example, the storage 958 may be implemented via a solid-state disk drive (SSDD) and/or high-speed electrically erasable memory (commonly referred to as “flash memory”). Other devices that may be used for the storage 958 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 954 and/or storage circuitry 958 may also incorporate three-dimensional (3D) cross-point (XPOINT) memories from Intel® and Micron®.

The memory circuitry 954 and/or storage circuitry 958 is/are configured to store computational logic 983 in the form of software, firmware, microcode, or hardware-level instructions to implement the techniques described herein. The computational logic 983 may be employed to store working copies and/or permanent copies of programming instructions, or data to create the programming instructions, for the operation of various components of system 900 (e.g., drivers, libraries, application programming interfaces (APIs), etc.), an operating system of system 900, one or more applications, and/or for carrying out the embodiments discussed herein. The computational logic 983 may be stored or loaded into memory circuitry 954 as instructions 982, or data to create the instructions 982, which are then accessed for execution by the processor circuitry 952 to carry out the functions described herein. The processor circuitry 952 and/or the acceleration circuitry 964 accesses the memory circuitry 954 and/or the storage circuitry 958 over the interconnect (IX) 956. The instructions 982 direct the processor circuitry 952 to perform a specific sequence or flow of actions, for example, as described with respect to flowchart(s) and block diagram(s) of operations and functionality depicted previously. The various elements may be implemented by assembler instructions supported by processor circuitry 952 or high-level languages that may be compiled into instructions 981, or data to create the instructions 981, to be executed by the processor circuitry 952. The permanent copy of the programming instructions may be placed into persistent storage devices of storage circuitry 958 in the factory or in the field through, for example, a distribution medium (not shown), through a communication interface (e.g., from a distribution server (not shown)), over-the-air (OTA), or any combination thereof.

The IX 956 couples the processor 952 to communication circuitry 966 for communications with other devices, such as a remote server (not shown) and the like. The communication circuitry 966 is a hardware element, or collection of hardware elements, used to communicate over one or more networks 963 and/or with other devices. In one example, communication circuitry 966 is, or includes, transceiver circuitry configured to enable wireless communications using any number of frequencies and protocols such as, for example, the Institute of Electrical and Electronics Engineers (IEEE) 802.11 (and/or variants thereof), IEEE 802.7.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 966 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 956 also couples the processor 952 to interface circuitry 970 that is used to connect system 950 with one or more external devices 972. The external devices 972 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 950, which are referred to as input circuitry 986 and output circuitry 984 in FIG. 9. The input circuitry 986 and output circuitry 984 include one or more user interfaces designed to enable user interaction with the platform 950 and/or peripheral component interfaces designed to enable peripheral component interaction with the platform 950. Input circuitry 986 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 984 may be included to show information or otherwise convey information, such as sensor readings, actuator position(s), or other like information. Data and/or graphics may be displayed on one or more user interface components of the output circuitry 984. Output circuitry 984 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 950. The output circuitry 984 may also include speakers and/or other audio emitting devices, printer(s), and/or the like. Additionally or alternatively, sensor(s) may be used as the input circuitry 984 (e.g., an image capture device, motion capture device, or the like) and one or more actuators may be used as the output device circuitry 984 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 950 may communicate over the IX 956. The IX 956 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 956 may be a proprietary bus, for example, used in a SoC based system.

The number, capability, and/or capacity of the elements of system 950 may vary, depending on whether computing system 950 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 950 may comprise one or more components of a data center, a desktop computer, a workstation, a laptop, a smartphone, a tablet, a digital camera, a smart appliance, a smart home hub, a network appliance, and/or any other device/system that processes data.

### Examples

Some non-limiting examples of various embodiments are provided below.

Example 1 may include an apparatus comprising: a voltage regulator; and a control circuitry coupled to the voltage regulator. The control circuitry is to: receive a sensed current that corresponds to a load current provided to a load of the voltage regulator; determine a prediction of a dynamic voltage ID (DVID) inrush current associated with a DVID change; and control a number of active phases of the voltage regulator based on the sensed current and the prediction of the DVID inrush current.

Example 2 includes the apparatus of example 1, wherein the prediction of DVID inrush current is determined based on a slew rate and an output capacitance of the voltage regulator.

Example 3 includes the apparatus of example 2, wherein the slew rate and output capacitance are predefined.

Example 4 includes the apparatus of example 1, wherein the number of active phases is controlled based on a sum of the sensed current and the prediction of the DVID inrush current.

Example 5 includes the apparatus of example 4, wherein, to control the number of active phases, the control circuitry is to compare the sum to one or more automatic phase scaling (APS) thresholds.

Example 6 includes the apparatus of example 1, wherein, to control the number of active phases, the control circuitry is to: turn on all phases of the voltage regulator in response to the DVID change, and then set the number of active phases based on the sensed current and the prediction of the DVID inrush current, wherein the number of active phases is less than all the phases.

Example 7 includes the apparatus of example 1, wherein to control the number of active phases, the control circuitry is to: determine a first number of active phases based on the sensed current and the prediction of the DVID inrush current; determine a second number of active phases based on the sensed current without taking into account the prediction of the DVID inrush current; and activate the greater of the first number of active phases or the second number of active phases.

Example 8 includes the apparatus of example 1, further comprising the load coupled to an output of the voltage regulator.

Example 9 includes the apparatus of example 8, wherein the load includes one or more processors.

Example 10 includes an integrated circuit comprising: one or more processors; a voltage regulator to provide a supply voltage to the one or more processors, wherein the voltage regulator includes multiple phases; and control circuitry coupled to the voltage regulator. The control circuitry is to: receive a dynamic voltage ID (DVID) change command to change a DVID of the voltage regulator; estimate a dynamic voltage ID (DVID) inrush current associated with the change of the DVID based on an output capacitance of the voltage regulator; and determine a number of the phases to be active based on the estimated DVID inrush current.

Example 11 includes the integrated circuit of example 10, wherein the control circuitry is further to obtain a sensed current of the voltage regulator, wherein the sensed current corresponds to a load current provided to the one or more processors, and wherein the number of the phases to be active is determined further based on the sensed load current.

Example 12 includes the integrated circuit of example 11, wherein to determine the number of active phases, the control circuitry is to: determine a sum of the sensed current and the estimated DVID inrush current; and compare the sum to one or more thresholds.

Example 13 includes the integrated circuit of example 10, wherein the DVID inrush current is estimated further based on a slew rate of the voltage regulator.

Example 14 includes the integrated circuit of example 10, further comprising a register to store a value of the output capacitance.

Example 15 includes the integrated circuit of example 10, wherein the control circuitry is to: activate all the phases of the voltage regulator in response to the DVID change, and then turn off one or more of the phases to leave the determined number of phases active.

Example 16 includes the integrated circuit of example 10, wherein the number of the phases is a first number of phases, and wherein the control circuitry is further to: determine a second number of phases based on a sensed load current without taking into account the estimated DVID inrush current; and activate the greater of the first number of phases or the second number of phases.

Example 17 includes one or more non-transitory, computer-readable media (NTCRM) having instructions, stored thereon, that when executed by one or more processors cause a control circuitry of a voltage regulator to: receive, from a power control unit of a load, a command to change an output voltage of the voltage regulator; receive a sensed current that corresponds to a load current provided to load of the voltage regulator; estimate an inrush current associated with the change in the output voltage; and control a number of active phases of the voltage regulator based on the sensed current and the estimated inrush current.

Example 18 includes the one or more NTCRM of example 17, wherein the inrush current is estimated based on a slew rate and an output capacitance of the voltage regulator.

Example 19 includes the one or more NTCRM of example 17, wherein the instructions, when executed, are further to cause the control circuitry to: determine a sum of the sensed current and the estimated inrush current; compare the sum to one or more thresholds; and control the number of active phases based on the comparison.

Example 20 includes the one or more NTCRM of example 17, wherein, to control the number of active phases, the control circuitry is to: turn on all phases of the voltage regulator in response to the command, and then set the number of active phases based on the sensed current and the estimated inrush current, wherein the number of active phases is less than all the phases.

Example 21 includes the one or more NTCRM of example 17, wherein to control the number of active phases, the control circuitry is to: determine a first number of active phases based on the sensed current and the estimated inrush current; determine a second number of active phases based on the sensed current without taking into account the estimated inrush current; and activate the greater of the first number of active phases or the second number of active phases.

Example 22 includes the one or more NTCRM of example 17, wherein the command is a dynamic voltage ID (DVID) command.

In the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

What is claimed is:

1. An apparatus comprising:
a voltage regulator; and
a control circuitry coupled to the voltage regulator, the control circuitry to:
receive a sensed current that corresponds to a load current provided to a load of the voltage regulator;
determine a prediction of a dynamic voltage ID (DVID) inrush current associated with a DVID change; and
control a number of active phases of the voltage regulator based on the sensed current and the prediction of the DVID inrush current.

2. The apparatus of claim 1, wherein the prediction of DVID inrush current is determined based on a slew rate and an output capacitance of the voltage regulator.

3. The apparatus of claim 2, wherein the slew rate and output capacitance are predefined.

4. The apparatus of claim 1, wherein the number of active phases is controlled based on a sum of the sensed current and the prediction of the DVID inrush current.

5. The apparatus of claim 4, wherein, to control the number of active phases, the control circuitry is to compare the sum to one or more automatic phase scaling (APS) thresholds.

6. The apparatus of claim 1, wherein, to control the number of active phases, the control circuitry is to:
turn on all phases of the voltage regulator in response to the DVID change, and then set the number of active phases based on the sensed current and the prediction of the DVID inrush current, wherein the number of active phases is less than all the phases.

7. The apparatus of claim 1, wherein to control the number of active phases, the control circuitry is to:
determine a first number of active phases based on the sensed current and the prediction of the DVID inrush current;
determine a second number of active phases based on the sensed current without taking into account the prediction of the DVID inrush current; and
activate the greater of the first number of active phases or the second number of active phases.

8. The apparatus of claim 1, further comprising the load coupled to an output of the voltage regulator.

9. The apparatus of claim 8, wherein the load includes one or more processors.

10. An integrated circuit comprising:
one or more processors;
a voltage regulator to provide a supply voltage to the one or more processors, wherein the voltage regulator includes multiple phases; and
control circuitry coupled to the voltage regulator, the control circuitry to:
receive a dynamic voltage ID (DVID) change command to change a DVID of the voltage regulator;
estimate a dynamic voltage ID (DVID) inrush current associated with the change of the DVID based on an output capacitance of the voltage regulator; and
determine a number of the phases to be active based on the estimated DVID inrush current.

11. The integrated circuit of claim 10, wherein the control circuitry is further to obtain a sensed current of the voltage regulator, wherein the sensed current corresponds to a load current provided to the one or more processors, and wherein the number of the phases to be active is determined further based on the sensed load current.

12. The integrated circuit of claim 11, wherein to determine the number of active phases, the control circuitry is to:
determine a sum of the sensed current and the estimated DVID inrush current; and
compare the sum to one or more thresholds.

13. The integrated circuit of claim 10, wherein the DVID inrush current is estimated further based on a slew rate of the voltage regulator.

14. The integrated circuit of claim 10, further comprising a register to store a value of the output capacitance.

15. The integrated circuit of claim 10, wherein the control circuitry is to:
activate all the phases of the voltage regulator in response to the DVID change, and then turn off one or more of the phases to leave the determined number of phases active.

16. The integrated circuit of claim 10, wherein the number of the phases is a first number of phases, and wherein the control circuitry is further to:
determine a second number of phases based on a sensed load current without taking into account the estimated DVID inrush current; and
activate the greater of the first number of phases or the second number of phases.

17. One or more non-transitory, computer-readable media (NTCRM) having instructions, stored thereon, that when executed by one or more processors cause a control circuitry of a voltage regulator to:
receive, from a power control unit of a load, a command to change an output voltage of the voltage regulator;
receive a sensed current that corresponds to a load current provided to load of the voltage regulator;
estimate an inrush current associated with the change in the output voltage; and
control a number of active phases of the voltage regulator based on the sensed current and the estimated inrush current.

18. The one or more NTCRM of claim 17, wherein the inrush current is estimated based on a slew rate and an output capacitance of the voltage regulator.

19. The one or more NTCRM of claim 17, wherein the instructions, when executed, are further to cause the control circuitry to:
determine a sum of the sensed current and the estimated inrush current;
compare the sum to one or more thresholds; and
control the number of active phases based on the comparison.

20. The one or more NTCRM of claim 17, wherein, to control the number of active phases, the control circuitry is to:
turn on all phases of the voltage regulator in response to the command, and then set the number of active phases based on the sensed current and the estimated inrush current, wherein the number of active phases is less than all the phases.

21. The one or more NTCRM of claim 17, wherein to control the number of active phases, the control circuitry is to:
determine a first number of active phases based on the sensed current and the estimated inrush current;
determine a second number of active phases based on the sensed current without taking into account the estimated inrush current; and
activate the greater of the first number of active phases or the second number of active phases.

22. The one or more NTCRM of claim 17, wherein the command is a dynamic voltage ID (DVID) command.
